(19) United States
(12) Patent Application Publication
(10) Pub. No.: US 2004/0163674 A1
(43) Pub. Date: Aug. 26, 2004

(54) Cleaning substrate with additive

(75) Inventors: Nicola John Policicchio, Mason, OH (US); Richard Joseph Sunberg, Oxford, OH (US); Vincenzo Catalfamo, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company

(21) Appl. No.: 10/782,322

(22) Filed: Feb. 19, 2004

Related U.S. Application Data
(60) Provisional application No. 60/448,364, filed on Feb. 19, 2003.
(60) Provisional application No. 60/448,745, filed on Feb. 20, 2003.

(51) Int. Cl. B08B 7/00

(52) U.S. Cl. 134/6; 134/42; 15/208; 15/209.1

(57) ABSTRACT

The present invention provides a cleaning sheet for cleaning a surface which includes an additive applied on at least one of the outer surfaces of the sheet. The additive can have a penetration value at 25° C. between 20 dmm and about 100 dmm. The additive can have a “relative tack” between 55% and 94%. The additive can be applied at a level between 0.1 g/m² and about 2.3 g/m². The cleaning sheet leaves low levels of residue on the surface which is cleaned with the sheet.

### CROSS-REFERENCE TO RELATED APPLICATIONS

This application claims the benefit of U.S. Provisional Application Nos. 60/448,364, filed Feb. 19, 2003 and 60/448,745 filed Feb. 20, 2003.

### FIELD OF THE INVENTION

This invention relates to cleaning sheets particularly suitable for removal and entrapment of dust, lint, hair, sand, food crumbs, grass and the like and which include an additive for increasing the cleaning efficacy of the sheets.

### BACKGROUND OF THE INVENTION

The use of nonwoven sheets for dry dust-type cleaning is known in the art. Such sheets typically utilize a composite of fibers where the fibers can be thermally or adhesively bonded or bonded via entangling or other forces. See, for example, U.S. Pat. No. 3,629,047 and U.S. Pat. No. 5,144,729. The cleaning sheets can be used either for hand dusting or in combination with a cleaning implement such as the SWIFFER® cleaning implement sold by The Procter & Gamble Company or the PLEDGE GRABT-IT® cleaning implement sold by the S. C. Johnson Company. When the cleaning sheet is used with a cleaning implement, the sheet is typically mechanically attached to the mop head of the cleaning implement, via grippers located on the top surface of the mop head, such that a portion of the cleaning sheet is in contact with the floor being cleaned in order to collect and trap soils such as dust, lint, crumbs and other particles. The cleaning performance of a cleaning sheet can be defined by its “cleaning efficacy”, which relates to the capability/ability of the sheet to remove and trap soil in terms of amount or weight of particulates being trapped in the sheet. The cleaning performance of a cleaning sheet can also be defined by its “cleaning efficiency” which relates to the surface of the sheet being actually used during the cleaning operation (in particular when the sheet is being used with a cleaning implement) in comparison to the total surface of the sheet.

Several attempts have been made to increase the “cleaning efficiency” of the mopping operation by changing the flat bottom surface of the implement to expose more of the cleaning sheet. For example, in order to increase the leading edge surface area between a cleaning sheet and the floor surface, a mop head is provided with a “crowned” or curved bottom surface allowing the mop head “to rock or tilt forward and backward” during the mopping operation and, as a result, to enable a greater portion of the sheet to be in contact with soil on the floor surface. An example of such a cleaning implement having a mop head with a crowned bottom surface is described in U.S. patent application Ser. No. 09/788,761 to Willman et al., filed Feb. 24, 2000, and assigned to The Procter & Gamble Company. In addition, the bottom surface of the cleaning implement can also have a three-dimensional texture in order to increase the open area between the contact surface of the cleaning sheet against the floor surface also described in U.S. patent application Ser. No. 09/788,761 to Willman et al.

A well-known solution to improve the mopping operation and increase the “cleaning efficacy” of a cleaning sheet is to make the sheet out of a synthetic non-woven material capable of developing an electrostatic charge during the mopping operation. It has been observed that the electrostatic charge created on the sheet enhances the “cleaning efficacy” as the sheet becomes capable of “attracting” various particles.

Another solution to increase the “cleaning efficacy” of a cleaning sheet is to include an additive to the cleaning sheet.

U.S. patent application Ser. No. 09/082,349 to Fereshtehkhou et al., filed May 20, 1998, and assigned to The Procter & Gamble Company, discloses a variety of additives which can be applied to the sheet in order to enhance the pick-up and retention of soils. However, Fereshtehkhou et al. do not address the problem of residue being left on the surface depending on the type and level of additive being applied on the cleaning sheet.

U.S. Pat. No. 5,599,550 to Kohlruss et al., issued Feb. 4 1997, discloses the use of waxes to enhance the performance of dusting sheets. In this patent, the substrate is biodegradable and, as such, is made essentially of natural rather than synthetic fibers and also discloses that it is preferable that the dusting sheet does not generate static electricity when wiped on a surface. This patent also discloses relatively high levels of additives which can result in residue left on the surface being cleaned. Consequently, the dust cloth disclosed by Kohlruss et al. provides substantially no electrostatic benefits and can potentially leave an unacceptable amount of residue on the surface being cleaned.

U.S. patent application Ser. No. 09/788,761 to Willman et al., filed Feb. 20, 2001 and U.S. patent application Ser. No. 09/821,953 to Willman et al., filed Mar. 30, 2001 both assigned to The Procter & Gamble Company disclose the use of polymeric additives to enhance large particle pick-up. These polymeric additives are defined as chemistries that are highly tacky or sticky in nature such as pressure sensitive adhesives, tackifiers and the like. Willman et al. disclose that the “stickiness” of the additive is not only controlled by the level and type of polymeric additive used, but also can further be controlled through the optional addition of low levels of waxes, oils or powders added directly into the polymeric additives or on top of the polymeric additives which in essence function as slip agents. Waxes and other components are also described in this patent as being beneficial in acting as a diluent for certain polymeric additives to aid in processing. However, these waxes are a minor component (less than about 10% by weight) relative to the polymeric additive. In addition, depending on the kind of surface being cleaned and depending on the method of cleaning the surface, an additive mainly comprising a polymeric additive can increase the friction between the cleaning sheet and the hard surface. This increase of frictions result in a reduction of the glide of the sheet on the hard surface. This loss of glide can render the sheet inconvenient to use since a greater amount of force is required to move the sheet across the surface.

The previous references disclose suitable additives for increasing the “cleaning efficacy” of the cleaning sheet when the cleaning sheet is used to remove particles from a hard surface such as a floor surface. In order to increase the “cleaning efficacy” of a sheet, it is possible to a relatively high amount of additive or to choose a “tackier” additive. Nevertheless, increasing the “cleaning efficacy” of the sheet is often made at the cost of a greater amount of residue left on the surface. When the cleaning sheet is used to clean a floor surface, the residue left is barely noticeable by the consumer and, as a result, does not alter the consumer perception of the cleaning sheet. However, more and more consumers are using cleaning sheets to clean other types of hard surfaces such as glass, mirrors, TV screens and the like where a small amount of residue is immediately noticeable and unacceptable to the consumer.

Accordingly, it is an object of this invention to overcome the problems of the prior art and particularly to provide a cleaning sheet coated with an additive which can increase the “cleaning efficacy” of the cleaning sheet without leaving an unacceptable amount of residue on the hard surface being cleaned while maintaining a satisfactory level of glide of the sheet on the hard surface.

### SUMMARY OF THE INVENTION

A cleaning sheet for cleaning a surface comprising a substrate comprising at least one layer of fibrous material, said substrate having a first side and a second side and an additive applied on at least said first side wherein said additive comprises a wax and wherein said additive has a penetration value at 25° C. of between about 20 dmm and about 100 dmm, and wherein said additive is applied on said first side at a level of between about 0.1 g/m² and about 2.3 g/m².

A cleaning sheet for cleaning a surface comprising a substrate comprising at least one layer of fibrous material, said substrate having a first side and a second side and an additive applied on at least said first side wherein said additive comprises a wax and wherein said additive has a penetration value at 25° C. of between about 20 dmm and about 100 dmm, and wherein said additive has a Rt which is between about 55% and about 94%.

A cleaning sheet for cleaning a surface comprising a substrate comprising at least one layer of fibrous material, said substrate having a first side and a second side and an additive applied on at least said first side wherein said additive comprises a wax and wherein said additive has a penetration value at 25° C. of between about 20 dmm and about 100 dmm, wherein said additive is applied on said first side and wherein said first side having said additive has a Df measured according to a “Glass Surface Test” between about 3.5 g/cm² and about 10 g/cm².

A cleaning sheet for cleaning a surface with a low level of residue comprising a substrate comprising at least one layer of fibrous material, said substrate having a first side and a second side and an additive applied on at least said first side wherein said additive comprises a micro-crystalline wax and wherein said additive has a penetration value at 25° C. of between about 30 dmm and about 100 dmm, wherein said additive is applied on said first side at a level between about 0.1 g/m² and about 2.3 g/m² and wherein the loss in gloss of said surface according to the “Residue Test Method” is less than about 25%.

A cleaning sheet for cleaning a surface comprising a substrate comprising at least one layer of fibrous material, said substrate having a first side and a second side and an additive applied on at least said first side wherein said additive comprises a wax, and wherein said first side coated with said additive has a Rt value between about 55% and about 94% and wherein said first side coated with said additive removes at least about 43% by weight of the particulates from said hard surface measured according to the “Soil Pick-up Test”.

A cleaning sheet for cleaning a surface comprising a substrate comprising at least one layer of fibrous material, said substrate having a first side and a second side and an additive applied on at least said first side wherein said additive comprises a wax, and wherein said first side coated with said additive has a Rt value between about 55% and about 94%, wherein said additive is applied on said first side at a level between about 0.1 g/m² and about 2.3 g/m² and wherein the loss in gloss of said surface according to the “Residue Test Method” is less than about 25%.

All documents cited herein are, in relevant part, incorporated herein by reference; the citation of any document is not to be construed as an admission that it is prior art with respect to the present invention.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All parts, ratios, and percentages herein, in the Specification, Examples, and claims, are by weight and all numerical limits are used with the normal degree of accuracy afforded by the art, unless otherwise specified.

### BRIEF DESCRIPTION OF THE DRAWINGS

FIG. 1 is a top view of a cleaning sheet having an additive;

FIG. 2 is a schematic representation of the “Rolling ball” experiment;

FIG. 3 is a schematic representation of the side view of the experiment of FIG. 2;

FIG. 4 is a schematic representation of the “Glass surface” experiment;

FIG. 5 is a schematic representation of the “Soil pick-up” experiment;

FIG. 6 is a top view of a cleaning sheet having an additive; and

FIG. 7 is an isometric view of a cleaning tool.

### DETAILED DESCRIPTION OF THE INVENTION

While not intending to limit the utility of the cleaning sheet herein, it is believed that a brief description of its use in association with a modern mopping implement will help elucidate the invention.

In heretofore conventional dry-cleaning operations with a cleaning sheet, the user wipes a hard surface with the cleaning sheet by holding the sheet in his/her hand or by attaching the sheet to a handle. In order to clean large surfaces such as floor surfaces, the common practice is to mechanically attach the cleaning sheet to the mop head of a cleaning implement and then mop the surface in order to trap particles into the cleaning sheet.

Conventional cleaning sheets are made of one or more nonwoven layer of material which is typically made via an hydroentanglement process in order to provide a fibrous material or fabric capable of trapping particles of various sizes.

In order to increase the cleaning efficacy of the sheet, modern cleaning sheets are made of materials which have the ability to develop an electrostatic charge when the sheet is rubbed against a hard surface. In addition, additives, such as waxes, oils, polymeric additives or mixtures of these, can be applied to these cleaning sheets in order to increase their cleaning efficacy by enhancing the particles pick-up and retention of the cleaning sheet. While these additives can significantly increase the cleaning efficacy of the sheet, they tend to leave a residue on the surface being cleaned. Although this residue may not be noticeable on floor surfaces, it becomes apparent on surfaces such as glass, mirror and the like.

In addition, typical additives tend to modify the ability of the sheet to glide on the surface to be cleaned. When a cleaning sheet is mechanically attached to the mop head of a cleaning implement such as the SWIFFER® or PLEDGE GRAB-IT® cleaning implements (respectively sold by the Procter & Gamble Company and the S.C. Johnson Company), the pressure applied by the user is transferred to the mop head via a handle. This pressure is apportioned over the relatively large bottom surface of the mop head. On the over hand, when the user uses his or her hands to wipe a hard surface, a greater pressure per surface area is applied on the sheet and tends to limit the ability of the sheet to glide on the surface being cleaned. This is particularly true when the additive is a pressure sensitive adhesive.

Although the previously discussed improvements, increased to a certain degree the cleaning efficacy of the cleaning sheets when it is used with a cleaning implement, it is believed that this cleaning efficacy can be further increased without resulting in unacceptable residue on the surface being cleaned and without limiting the ability of the sheet to glide on a hard surface by a careful selection of the type and level of additive applied on the sheet.

The foregoing considerations are addressed by the present invention, as will be clear from the detailed disclosures which follow.

Reference will now be made in detail to the present preferred embodiments of the invention, examples of which are illustrated in the accompanying drawings wherein like numerals indicate the same elements throughout the views and wherein reference numerals having the same last two digits (e.g., 20 and 120) connote similar elements.

I. Definitions

As used herein, the term “comprising” means that the various components, ingredients, or steps, can be conjointly employed in practicing the present invention. Accordingly, the term “comprising” encompasses the more restrictive terms “consisting essentially of” and “consisting of”.

As used herein, the term “hydroentanglement” means generally a process for making a material wherein a layer of loose fibrous material (e.g., polyester) is supported on an apertured patterning member and is subjected to water pressure differentials sufficiently great to cause the individual fibers to entangle mechanically to provide a fabric. The apertured patterning member can be formed, e.g., from a woven screen, a perforated metal plate, etc.

As used herein, the term “layer” refers to a member or component of a cleaning sheet whose primary dimension is X-Y, i.e., along its length and width. It should be understood that the term layer is not necessarily limited to single layers or sheets of material. Thus the layer can comprise laminates or combinations of several sheets or webs of the requisite type of materials. Accordingly, the term “layer” includes the terms “layers” and “layered.”

For purposes of the present invention, an “upper” layer of a cleaning sheet is a layer that is relatively further away from the surface that is to be cleaned (i.e., in the implement context, relatively closer to the implement handle during use). The term “lower” layer conversely means a layer of a cleaning sheet that is relatively closer to the surface that is to be cleaned (i.e., in the implement context, relatively further away from the implement handle during use). Reciprocally, the “top surface” of a layer or cleaning sheet is the surface that is relatively further away from the surface to be cleaned. The term “bottom surface” conversely means the surface of the layer or cleaning sheet that is relatively closer to the surface that is to be cleaned, during a typical cleaning operation.

II. Cleaning Sheet with Additive

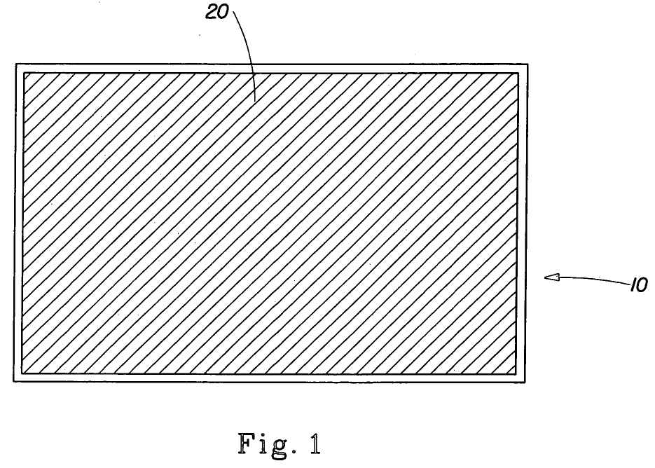

Referring to FIG. 1, the bottom surface of a cleaning sheet 10 coated with an additive 20 is represented. The cleaning sheet 10 described herein can be made using either a woven or nonwoven substrate(s) via a several processes. Non-limiting example of processes suitable to make the cleaning sheet include forming operations using melted materials laid down on forms, especially in belts, forming operations involving mechanical actions/modifications carried out on films, imaging/patterning process involving an imaging device having a drum with an imaging surface and/or by embossing operations and combinations thereof. The substrates used for the cleaning sheet 10 can made by any number of methods (e.g., hydroentangled, spunbonded, meltblown, carded resin bonded, carded through air-bonded, carded thermal bonded, air laid, etc.), once the essential three dimensional dimensions and basis weight requirements are determined. However, the preferred substrates are nonwoven, and especially those formed by hydroentanglement as is well known in the art, since they provide highly desirable open fibrous structures. Therefore, preferred cleaning sheets are nonwoven substrates having the characteristics described herein. Materials particularly suitable for forming the preferred nonwoven cleaning sheet when used with an additive 20 include, for example, natural cellulosics but preferably synthetics such as polyolefins (e.g., polyethylene and polypropylene), polyesters, polyamides, synthetic cellulosics (e.g., RAYON®), and blends thereof. Also useful are natural fibers, such as cotton or blends thereof and those derived from various cellulosic sources. Preferred starting materials for making the hydroentangled fibrous sheets are synthetic materials, which may be in the form of carded, spunbonded, meltblown, airlaid, or other structures. Particularly preferred are polyesters, especially carded polyester fibers. The degree of hydrophobicity or hydrophilicity of the fibers is optimized depending upon the desired goal of the sheet, either in terms of type of soil to be removed, biodegradability, availability, and combinations of such considerations. In general, the more biodegradable materials are hydrophilic, but the more effective materials tend to be hydrophobic.

The cleaning sheet 10 may be formed from a single fibrous layer, but preferably is a composite of at least two separate layers. Preferably, the sheet 10 is a nonwoven made via a hydroentangling process. In this regard, prior to hydroentangling discrete layers of fibers, it may be desired to slightly entangle each of the layers prior to joining the layers by entanglement.

In one embodiment, the cleaning sheet 10 is textured to optimize the cleaning surface available on the sheet. In a preferred embodiment, the cleaning sheet 10 has a macroscopic three-dimensional pattern. Non-limiting examples of suitable methods to create a macroscopic three-dimensional pattern on at least one of the outer surfaces of the cleaning sheet 10 include applying heat to a substrate comprising at least one layer of nonwoven material hydroentangled with a scrim in order to cause this scrim to shrink and is disclosed in U.S. patent application Ser. No. 09/082,396 to Fereshtehkhou et al., filed May 20, 1998, and assigned to The Procter & Gamble Company, as well as providing at least one of the outer surfaces of a cleaning sheet with a plurality of pillow members such as the ones described in copending patent application 60/448,396 to Wong et al., filed Feb. 19, 2003, and assigned to The Procter & Gamble Company.

As previously discussed, at least one of the outer surfaces of the sheet comprises an additive for increasing the cleaning efficacy of the cleaning sheet. Among the various types of additives capable of increasing the cleaning efficacy of the sheet, an additive comprising a wax is preferred.

Waxes can be classified into several categories including insect/animal waxes, such as beeswax (from honey comb structures) or spermaceti from sperm whale; vegetable waxes such as carnauba, candelilla, Japan wax; mineral waxes such as montan, ozokerite, ceresine; petroleum based waxes such paraffin (or macro-crystalline) and micro-crystalline waxes; and synthetic waxes such as polyethylene.

In one embodiment, the additive 20 comprises a petroleum based wax. One skilled in the art will appreciate that petroleum based waxes typically range in chain length from C₁₀H₂₂ to C₅₀H₁₀₂ based on the generic formula CₙH₂ₙ₊₂. As previously discussed, petroleum based waxes can be classified as paraffins (also called macro-crystalline) and micro-crystalline waxes. Paraffins are typically obtained by de-oiling slack/scale wax, which is derived by de-waxing base distillate lube oil streams. These streams are primarily straight chain alkanes. Paraffins after processing have low affinity for oil. This low affinity for oil renders the paraffin brittle and provides them with a low melting point. Micro-crystalline waxes are also petroleum based, but unlike paraffins, micro-crystalline waxes contain branched and cyclic saturated hydrocarbons. Unlike paraffin waxes, oil is held tightly by micro-crystalline waxes, and consequently does not migrate to the outer surface of the wax. The affinity for tightly holding oil renders micro-crystalline waxes “softer” and more tacky than paraffins and other waxes.

It has been observed that the hardness of the wax is a relevant factor to determine the cohesive characteristics of an additive comprising a wax or wax mixture. The cohesive characteristic is defined as the ability of the wax or wax mixture to stick to itself without “breaking apart”. Consequently, the lower the cohesive characteristic of the wax or wax mixture of the additive, the greater is the chance to have residue left on the surface during the cleaning operation. In addition, an additive increases the cleaning efficacy of a sheet by enhancing pick-up and retention of particulates. In order to enhance pick-up and retention of particulates on the sheet, an additive comprising a wax or a wax mixture should also demonstrate good tack or adhesive properties.

Waxes that are relatively hard (i.e., degree of penetration less than about 15 dmm), such as paraffin, carnauba, ceresine wax, and ozokerite wax, have good cohesive properties but demonstrate relatively little tack. The hardness of an additive comprising a wax can be determined via a penetration test such as the ASTM standard test D1321. This test measures the depth in tenths of a millimeter that a needle of a certain configuration under a given weight penetrates the surface of a wax at a given temperature. The degree of hardness of an additive can be measured with a penetrometer, which applies a needle to a sample of additive for about 5 seconds under a load of pressure of about 100 g. The penetration needle used for this test can be obtained from VWR Scientific Products catalog # 52934-163 for waxes having penetration no greater than 250 dmm. This needle has a tapered point blunted at the tip of a truncated cone. The needle is a hardened, highly polished stainless steel having a diameter of about 4.3 mm and a length of about 83 mm. The needle is attached to a caliper gauge from Chicago Dial Indicator Company, Des Plaines, Ill. P/N CO 1912-1 mounted on a 20.3 cm×30.5 cm granite base. A weight is added to a shaft located above the penetrometer needle such that the total potential load on the needle is about 100 g+0.15 g. The release mechanism should not drag on the shaft and the indicator on the scale is zeroed. The tip of the needle is slowly brought in contact with the top surface of the additive being tested. The needle is left in this position for about 5 minutes and then released for a period of about 5 seconds. The penetration depth of the needle into the additive is recorded in tenth of millimeters. After each test, the needle is cleaned with a clean dry cloth to remove any adhering wax residue. A same additive sample is tested four times on four distinct locations which are equally spaced (but preferably not less than 12.7 mm apart). The penetration values of each of the additive samples which are tested are compared with the penetration values obtained from the manufacturer of these additives in order to standardize the previously described penetration test. The penetration values obtained via the preceding test method are consistent with the certified penetration values of each sample within ±2 units of penetration. One skilled in the art will understand that the lower the penetration value of an additive (or wax), the harder and the more coherent is the additive. On the other hand, when the penetration value of an additive is relatively high, the additive is considered as being “soft” and has relatively poor cohesion properties. Examples of additives having a high penetration value include additive having a high amount of oil and oil-like chemistries such as mineral oil, petroleum jelly, fatty acids, fatty alcohols and surfactants. While additives having a high amount of oil are relatively “tackier” than hard waxes, these tend to be too soft with poor cohesive strength and therefore are prone to leave a residue. It has been observed that mixing an oil and oil like component with hard waxes can lead to a softer mixture, but that nevertheless, the adhesive properties of the mixture are fairly limited. Additionally, the cohesive properties of an oil and wax mixture can also be negatively affected. Without intending to be bound by any theory, it is believed that an additive comprising a hard wax and oil (such as mineral oil) mixture at relatively high ratios (e.g., 90% hard wax: 10% oil), the liquid phase of the mixture can tend to segregate from the wax upon setting. In other words, some of the liquid oil component migrates to the outer surfaces of the wax. As a result, when such an additive is coated on a substrate, a first layer substantially comprising the wax component of the additive is formed on the substrate and a second layer substantially comprising the oil component is formed on top of the wax layer. During the cleaning operation of a hard surface, this second layer (or outer layer) is in contact with the hard surface and leaves a residue on the surface.

In one embodiment, the additive 20 comprises a wax and has a penetration value at 25° C. comprised between about 20 dmm and about 100 dmm, preferably between about 25 dmm and about 90 dmm, more preferably between about 25 dmm and about 80 dmm. Among other benefits, when a dusting sheet is coated with such an additive, particles and in particular large particles (i.e., greater than about 0.5 mm in diameter) can more easily penetrate into the coating. As a result, this additive increases the cleaning efficacy of the cleaning sheet.

As previously discussed, an additive comprising a wax should also demonstrate a certain degree of tackiness. In order to evaluate the degree of tackiness of a wax, a simple finger squeeze test can be done. In this test, a person takes a small amount (about 5 g sample) of additive (or wax when wax is the only constituent of the additive) and places it onto the finger print area of the middle finger. Using the finger print area of the thumb, the person squeezes down onto the wax in a rolling motion for about 5 seconds. Then, the person carefully separates the thumb away from the middle finger. An additive comprising waxes or wax mixtures having a high degree of tack typically requires a greater force to separate the thumb from the middle finger in comparison to an additive which has a low degree of tack which typically require very little force.

Table 1 includes the penetration values and degree of tackiness of a variety of waxes which are commercially available.

TABLE 1

| | Penetration | | Melting- |
|---|---|---|---|
| Wax Description | at 25° C. | Tackiness | Point |
| (Supplier and Code) | (dmm) | Amount | (° C.) |
| 1. Montan | <1 | None | 79-91 |
| 2. Carnauba | 2 | None | 82-88 |
| 3. Candelilla | 3 | None | 68-71 |
| 4. Paraffin waxes | 11 to 18 | None | 46-74 |
| 5. Beeswax | 25 | Slight | 63-66 |
| 6. Micro-crystalline wax (Koster | 25 | Slight | 74-79 |
| Keunen 227) | | | |
| 7. Micro-crystalline wax (Koster | 63 | Moderate | 74-79 |
| Keunen 161S) | | | |
| 8. Micro-crystalline wax (Frank | 70 | Moderate | 74-79 |
| Ross 1275WH) | | | |
| 9. Micro-crystalline wax (Strahl | 28 | Slight | 79-82 |
| & Pitsch #19) | | | |
| 10. Micro-crystalline wax Strahl | 63 | Moderate | 74-79 |
| & Pitsch #18 | | | |
| 11. Micro-crystalline wax | 70 | Moderate | 74-79 |
| (Schaeffer #7) | | | |
| 12. Micro-crystalline wax | 40 | Slight to | 57-63 |
| (Honeywell Astor AW 3040) | | Moderate | |

From the results of these two tests, it is found that certain micro-crystalline waxes have a suitable penetration value as well as good tack properties. Without intending to be bound by any theory, it is believed that this balance between penetration value and tack properties is due to the crystalline/chemical structure of these micro-crystalline waxes. As previously discussed, micro-crystalline waxes are composed of highly branched and cyclic molecules which result in the formation of smaller crystals. This crystalline/chemical structure gives to the microcrystalline waxes their relatively high capability to retain oils and makes the micro-crystalline waxes softer. In addition, it is believed that the branching properties of the micro-crystalline waxes give to the micro-crystalline waxes their good tack properties (see examples 6 through 12).

In one embodiment, the additive 20 comprises a micro-crystalline wax such that the additive has a penetration value of between about 30 dmm and about 100 dmm, preferably between about 35 dmm and about 90 dmm, more preferably between about 40 dmm and about 80 dmm.

In one embodiment, the additive 20 comprises a micro-crystalline wax having a penetration value of less than about 30 dmm, preferably less than about 20 dm and an oil, preferably a mineral oil, such that the additive obtained by mixing the wax and the oil has a penetration value between 30 dmm and about 100 dmm, preferably between about 35 dmm and about 90 dmm, more preferably between about 40 dmm and about 75 dmm. In one embodiment, the ratio micro-crystalline wax to oil in the additive is between about 7:3 and 9:1, preferably between about 8:2 and about 9:1.

In a preferred embodiment, the tack properties of relatively harder waxes (i.e., having a penetration value of less than about 20 dmm) can be improved by adding a tacky polymer to the wax, preferably a low level of tacky polymer. The addition of a tacky polymer to a relatively harder wax increases penetration value (i.e., cohesion) of the additive as well as its tack properties. Non-limiting examples of suitable tacky polymers include polyisobutylene polymers, alkyl methacrylate polymers, polyalkyl acrylates, polydecenes, natural and mixtures thereof.

In one embodiment, the tacky polymer can be replaced by modified resins and still provide the same benefits. Non-limiting example of modified resins include polyterpene resins, phenolic modified hydrocarbon resins, coumarone-indene resins, aliphatic and aromatic petroleum hydrocarbon resins, phthalate esters, hydrogenated hydrocarbons, hydrogenated rosins, hydrogenated rosin esters and mixtures thereof.

In one embodiment, the additive 20 comprises a wax and a tacky polymer such that the penetration value of the additive is between about 30 dmm and about 100 dmm, preferably between about 35 dmm and about 90 dmm, more preferably between about 40 dmm and about 80 dmm. In one embodiment, the ratio wax to tacky polymer in the additive is between about 6:4 and 9:1, preferably between about 7:3 and 9:1 and more preferably between 8:2 and 9:1.

In a preferred embodiment the additive comprises a microcrystalline wax and a tacky polymer such that the penetration value of the additive is between about 30 dmm and about 100 dmm, preferably between about 35 dmm and about 90 dmm, more preferably between about 40 dmm and about 80 dmm and such that the ratio micro-crystalline wax to tacky polymer in the additive is between about 6:4 and 9:1, preferably between about 7:3 and 9:1 and more preferably between 8:2 and 9:1. It has been observed that when the ratio of wax to tacky polymer is lower than 6:4, the additive obtained can be too stringy resulting in poor cohesive properties, which lead to possible residue problems.

One skilled in the art will understand that the miscibility between a wax and a tacky polymer can have an impact on the final properties of the additive as well as on the cleaning efficacy of a cleaning sheet. The additive can be made by melting and mixing a wax and a polymeric additive together. In order to optimize the properties of the additive on the cleaning sheet, the mixture is preferably substantially homogeneous both in its liquid (molten) and its solid phase (i.e., on the sheet). In the solid phase some but not all of the tacky polymer can be present on the outer surface of the additive. If too much of the tacky polymer is the outer surface it could cause unacceptable glide and/or residue issues particularly on glossy surfaces such as glass, mirrors and the likes. However, it is preferred that some of the tacky polymer be present on the outer surface of the additive to provide tack benefits.

One suitable method to prepare an additive comprising a wax or wax and tacky polymer mixture, is to heat the wax or wax and tacky polymer mixture 10 to 40° C. above the actual melting point. Among other benefits, heating the wax or wax and tacky polymer mixture 10 to 40° C. above the actual melting point prevents the resulting additive to set too fast on the substrate which could cause an uneven coverage of the additive on the substrate. In one embodiment, the wax or wax and tacky polymer mixture have a melting point less than about 93° C., preferably less than about 80° C. and more preferably less than about 65° C. in order to minimize extreme heat. Extreme heat can be cause safety issues at the processing/manufacturing site but it can also cause feasibility issues in particular if the temperature of the additive when it is coated on a substrate is higher than the melting point of the substrate.

Additive Levels and Distribution

As previously discussed, the amount of additive applied on at least one of the outer surfaces of the sheet is preferably such that while it enhances the tack properties, it does not substantially produce residue and/or does not significantly reduce the ability of the sheet to be electrostatically charged.

In one embodiment, the additive is applied on one of the outer surfaces of the sheet at low levels (expressed in grams of additive per square meter of substrate) of between about 0.1 g/m² and about 2.3 g/m², preferably between about 0.25 g/m² and about 2.0 g/m² and more preferably between about 0.4 g/m² and about 1.7 g/m². In another embodiment, both outer surfaces of a cleaning sheet are coated with an additive. In one embodiment, the first and the second outer surfaces of a sheet can have different levels of additives.

Among other benefits, applying a low level of additive on a cleaning sheet limits the risk of residue left on the surface to be cleaned and in addition, has little if no impact on the ability of the sheet to be electrostatically charged during the cleaning operation. Surprisingly, it is found that even a very low level of additive on a cleaning sheet can significantly increase the cleaning efficacy of the cleaning sheet

The distribution of the additive across the outer surface(s) of the sheet can have an impact the soil pick-up performance of the sheet. Since waxes in a solid state are typically white, a low level of oil soluble dye is added into the wax (about 0.25% by weight) in order to visualize the distribution of the additive comprising a wax across the outer surface(s) of the substrate. An example of such a dye is Pylakrome Red LX1903 sold by Pylam Products Company Inc. It is found that the soil pick-up ability of the sheet is increased and the amount of residue left on the hard surface is reduced when the additive containing a wax is distributed in a substantially thin even layer across the outer surface(s) of the sheet. When the additive creates uneven clumps or blobs, a greater amount of residue can be seen on the hard surface and the soil pick-up ability of the sheet is reduced. This effect is particularly noticeable when the additive comprises a micro-crystalline wax. Without intending to be bound by any theory, it is believed that when a low level of additive is spread on the outer surface of the sheet, the outer surface appears to have a thin even layer on a macroscopic level. On a microscopic level, it appears that the additive forms micro-droplets or blobs on the fibers of the substrate. As a result, some of the tacky longer chain components of the micro-crystalline wax or micro-crystalline wax mixtures are located adjacent to the outer surface of the wax layer after the wax has had time to set. It is also believed that when the additive comprising a wax forms macro-blobs (i.e., greater than about 100 μm) on the outer surface of the substrate, the less tacky shorter chain components tend to encase the tackier branched chain components. As a result, the outer surface of the sheet coated with the additive is not as tacky and consequently, the sheet has a lower cleaning efficacy.

An automatic wax coating machine can be used in order to apply an additive comprising a wax substantially evenly on the outer surface(s) of a sheet. For testing purposes, several cleaning sheets are coated with various types of additives with an automated wax coating machine such as the Model C-14 manufactured by Schafer Machine Co., Deep River, Conn. About 250 grams of wax are placed in a wax pan and the temperature of the pan is progressively increased until it reaches the melting point temperature of the wax. Once the wax is in a liquid phase, the temperature of the pan is then further increased by about 10° C. to ensure that the wax does not solidify immediately when it is applied to substrate. The non-coated sheets are weighed and then placed through the rolls of the auto-coater. The sheets are then re-weighed to measure the amount of additive applied on the sheets. If necessary, the doctor blade on the machine can be adjusted in order to increase or decrease the weight amount of additive on the sheets.

In order to evaluate the optimum degree of tackiness of an additive, the following test is conducted.

Rolling Ball Tack Test Method

It has been observed that both the amount of additive coated on the sheet and the distribution of the additive across a sheet can have an impact on the cleaning performance as well as on the amount of residue left on the hard surface.

Various coatings are applied to specific substrates and the substrate is subsequently tested using an ASTM test #D3121 referred to as the “Rolling Ball Tack test”.

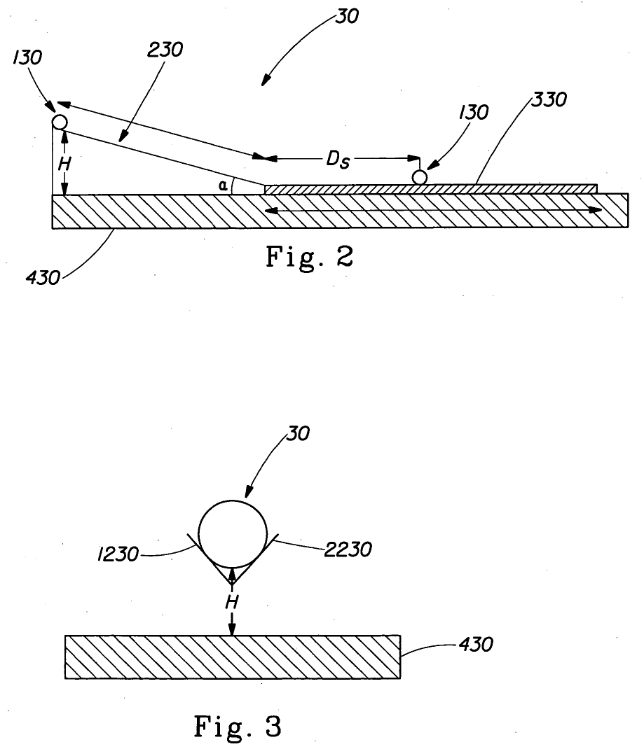

The “Rolling Ball Tack test” 30 is schematically represented in FIGS. 2 and 3. A steel ball 130 of about 1.1 cm in diameter and which weights about 5.7 g is allowed to roll down an incline 230 and then on the outer surface of a substrate 330 which is coated with an additive in order to measure the tack capacity of the additive. Before letting the ball roll down the incline, the ball is cleaned with a solution of Isopropyl Alcohol (hereinafter IPA) and then dried. The metal ball 130 is also cleaned and dried after each test. The substrate is placed on a leveled work surface (such as a table top or glass plate) such that the leading edge of a 215×279 mm substrate sample is placed in direct contact with the bottom edge of the incline as shown in FIG. 2. The work surface 430 is level, hard and smooth. The incline is a pair of hard plastic, US. Standard Architect rulers (Helix Model #18170 from Helix Ltd., West Midlands, United Kingdom) 1230 and 2230 (shown in FIG. 3) secured together side by side to create a 90 degrees V shaped groove for the steel ball 130 to roll down onto the substrate which is laid flat on the work surface. The angle α between the incline and the work surface is about 5 degrees. The ball 130 is in contact with two sides of the V shape groove and is located at a height H of about 13 mm from the work surface 430 (as shown in FIG. 3). The ball is held in position by a metal pin. The pin is removed to release the ball. The ball rolls down by gravity for about 16.7 cm until it reaches the top surface of the sample substrate 330. After allowing the ball 130 to roll down the incline 230 and then to a complete stop on the substrate, the distance Ds from the edge of the bottom of the incline to the center of the ball on the substrate is measured and recorded. Each sample test sheet is tested 5 times along the middle two-third portion of the sheet. After each test, the sheet is moved slightly such that the ball rolls on an untested portion of the same sheet. Three samples of each sheet are tested on 5 different spots for a total of 15 replicates. The results are then averaged. In order to determine the degree of tack of the sheet, the average distance traveled by the ball along a coated sheet is compared to the average distance traveled by the ball on a reference sheet. In order to evaluate the effect of an additive comprising a wax on various substrates, the reference sheet is made of the same substrate material than the sheet coated with the additive being tested. One of the reference sheets chosen for this experiment is an non-coated SWIFFER® cleaning substrate. Several sheets made of the same substrate are then coated with various chemistries and tested according to the rolling ball test.

Tables 3 and 4 include the results of the “Rolling Ball Test.”

Based on the results provided in table 3, it is possible to evaluate a “Relative Tack” Rt which is equal to the distance traveled by the metal ball on the substrate coated with the test sample additive divided by the distance traveled by the metal ball on an identical substrate which does not comprise the test sample additive. This result is then multiplied by 100 to obtain a percentage value.

In one embodiment, a cleaning sheet 10 comprises an additive 20 comprising a wax, preferably a micro-crystalline wax which is coated on at least one of the outer surfaces of the sheet such that Rt is between about 55% and about 94%, preferably between about 60% and about 92%, more preferably between about 65% and about 90%.

In one embodiment, a cleaning sheet 10 comprises an additive 20 comprising a wax, preferably a micro-crystalline wax and a tacky polymer, which is coated on at least one of the outer surfaces of the sheet such that Rt is between about 50% and about 94%, preferably between about 55% and about 92%, more preferably between about 60% and about 90%.

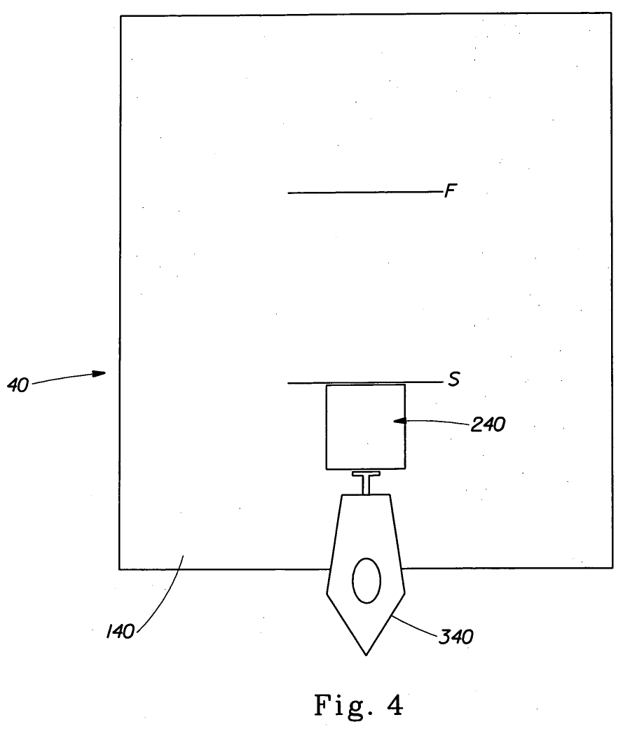

As previously discussed, an additive applied on a cleaning sheet can reduce the glide of the sheet when the sheet is moved across a hard surface. If the additive is too tacky, it becomes harder and less convenient for the user to wipe a hard surface with a sheet. This reduction in glide can have a negative impact on the user's perception of the sheet. In order to measure the ability of a sheet to glide on a hard surface, the following “Glass Surface Test” 40, schematically represented in FIG. 4, is performed

Glass Surface Test Method

A mirror 140 of about 26.5 cm×51 cm (about 10.5×20 inches) is placed on a bench top. The mirror surface is first cleaned using about 5 mls of a WINDEX® glass cleaner solution and dried with BOUNTY® paper towels to remove any grease from the top surface of the mirror. The mirror is then cleaned with about 5 mls of a 20% IPA solution and dried with new pieces of BOUNTY® paper towel. The mirror surface is then cleaned one more time with about 5 mls of distilled water solution and dried with new pieces of BOUNTY®. A “starting” S line is drawn on the top surface of the mirror at about 130 mm from its leading edge using a marker. A “finish” line F is drawn at about 130 mm in front of “starting” line mark. A rectangular block 240 of PLEXIGLAS® measuring about 65 mm wide, about 100 mm long and about 50 mm high and comprising a metal handle to manipulate the block and having a total weight of about 230 grams is used to simulate a compressive load of about 3.2 g/cm². A dusting sheet measuring about 215×279 mm is wrapped around the block such that the coated surface of the sheet faces outwardly. The surface of the sheet in contact with the mirror surface is about 65 cm². The block and the sheet are then placed before the “starting line” as shown in FIG. 4 such that the coated surface of the sheet is in contact with the top surface of the mirror.

A force gauge 340 (e.g. MF Shimpo Mode 022598 with 12 mm circular flat head) which has been zeroed prior to the test, is used to push slowly the block 240 forward until the back edge of the block 240 passes the finish line F. The force read on the force gauge 340 is recorded and rounded to the nearest gram. The test is repeated twice with the same sheet. The absolute value of force measured to move the block and sheet across the mirror surface is divided by the total surface of the sheet in contact with the mirror surface in order to obtain a “Drag Force density” Df expressed in g/cm² representing the force required to move 1 cm² of substrate under a compressive force of about 3.2 g/cm² across a hard surface.

Once this part of the test is completed for a first cleaning sheet sample, the top surface of the mirror is inspected and graded for visual residue. The surface is graded on a 0 to 4 scale where 0 is none (i.e., no visible residue), 1 is slight, 2 is moderate, 3 is heavy and 4 is very heavy and the results are recorded for this cleaning sheet.

In order to test another sheet sample, the area of the mirror with visible residue is buffed using two pieces of BOUNTY® paper towel folded into quarters. This area is buffed in a circular motion (about 10 circular strokes) and by applying a firm pressure of about 35.2 g/cm². The top surface is re-inspected and re-graded for residue using the same 0 to 4 scale as previously discussed. If residue remains on the surface of the mirror, this surface is cleaned with about 3 mls of WINDEX® standard glass cleaner. The surface is then wiped with two pieces of BOUNTY® paper towel folded into quarters in a circular motion (about 10 circular strokes). Once the top surface has dried, the surface is re-inspected for residue and graded using the 0 to 4 scale.

The top surface of the mirror is then cleaned following the original cleaning instructions. Three identical cleaning sheets are tested and evaluated for each type of additive the results which have been recorded are averaged for “Glide”, “Initial Residue”, “Residue after dry buffing” and “Residue after wet buffing”.

Non-coated substrates, such as the one used for the SWIFFER® cleaning sheets are coated with various additives comprising waxes, tacky polymers and mixtures of waxes and tacky polymers. A Schafer auto-coater is used to apply the additive on one of the outer surfaces of the sheets. Each sheet is then tested according to the previously described “Glass Surface Test” method.

Sheets coated with an additive comprising hot melt materials are coated using a Pam 600 Spraymatic glue gun manufactured by Fastening Technologies Inc. The latex based polymers are dissolved in a solution of 50% deionized water and 50% IPA. They are then placed in a container and applied using a Preval Spray Gun manufactured by Precision Valve Corporation. These sheets are then allowed to sit until the aqueous portion substantially evaporates leaving only the tacky polymer on the surface of the sheet.

Table 2 includes the results comparing different additives.

TABLE 2

| | | Coating Type | | | | | |
|---|---|---|---|---|---|---|---|
| | | Supplier | Glide | | Residue | Dry Buffing | Wet Cleaning |
| | | Amount (g/side) | Resistance | Df | Left | Residue Left | Residue Left |
| Example | Substrate | Amount (g/m²) | (g_{f}) | (g/cm²) | (0 to 4 scale*) | (0 to 4 scale | (0 to 4 scale) |
| 1 | Swiffer | No coating | 277 | 4.3 | 0 | 0 | 0 |
| 2 | Swiffer | Paraffin Wax | 219 | 3.4 | Between | 0 | 0 |
| | | 0.04 g/side˜ | | | 0 and 1 | | |
| | | 0.66 g/m² | | | | | |
| 3 | Swiffer | Micro-crystalline Wax | 252 | 3.9 | Between | 0 | 0 |
| | | Koster Keunen 227 | | | 0 and 1 | | |
| | | 0.04 g/side˜ | | | | | |
| | | 0.66 g/m² | | | | | |
| 4 | Swiffer | Micro-crystalline Wax | 260 | 4 | Between | 0 | 0 |
| | | Koster Keunen 161S | | | 0 and 1 | | |
| | | 0.04 g/side˜ | | | | | |
| | | 0.66 g/m² | | | | | |
| 5 | Swiffer | 80% Micro-crystalline Wax | 279 | 4.3 | 1 | Between | 0 |
| | | Koster Keunen 227 and | | | | 0 and 1 | |
| | | 20% Polyisobuytelene | | | | | |
| | | (Vistanex LM-MS-LC by | | | | | |
| | | ExxonMobil) | | | | | |
| | | 0.04 g/side˜ | | | | | |
| | | 0.66 g/m² | | | | | |
| 6 | Swiffer | 70% Paraffin Wax and | 312 | 9.4 | Between | 1 | 0 |
| | | 30% Polyisobuytelene | | | 1 and 2 | | |
| | | (Vistanex LM-MS-LC by | | | | | |
| | | ExxonMobil) | | | | | |
| | | 0.04 g/side˜ | | | | | |
| | | 0.66 g/m² | | | | | |
| 7 | Swiffer | Hot Melt | 931 | 14.3 | 3 | Between | 2 |
| | | HB Fuller HL 2713 | | | | 2 and 3 | |
| | | 0.04 g/side˜ | | | | | |
| | | 0.66 g/m² | | | | | |
| 8 | Swiffer | Latex Base PSA | 681 | 10.5 | Between | 2 | 1 |
| | | Robond PS75R by | | | 2 and 3 | | |
| | | Rohm & Haas | | | | | |
| | | 0.04 g/side˜ | | | | | |
| | | 0.66 g/m² | | | | | |

The cleaning sheet of example 1 does not have any additive and consequently, does not leave any residue on the mirror surface.

Examples 3 and 4 show that when a substrate is coated with an additive comprising a micro-crystalline wax, its glide capability is slightly better than the glide capability of the non-coated substrate of example 1 since the force required to move the sheet coated with these additives across the mirror surface is less than the force required to move the non-coated sheet. In addition, examples 3 and 4 show that the residue left on the surface for these sheet is substantial identical to residue left by a cleaning sheet coated with a hard wax such as the paraffin of Example 2.

Example 5 shows that a low level of tacky polymer can be added to a micro-crystalline wax to form an additive without having an excessive negative impact on the glide capability or residue left by the sheet.

Example 6 shows that when the same tacky polymer is added to a harder paraffin wax, the glide capability and residue left on the surface start to degrade as compared to the additive comprising a micro-crystalline wax.

Examples 7 and 8 show that when a substrate is coated with an additive being essentially made of a tacky polymer, the glide capability is too low as the force required to move the sheet across the surface is high and renders the substrate inconvenient to use. In addition, these substrates coated with tacky polymers lead to an unacceptably high level of residue which cannot be easily buffed off and therefore could lead to build-up on glass surfaces.

In one embodiment, at least one of the outer surfaces of a cleaning sheet 10 is coated with an additive 20 comprising a wax, preferably a micro-crystalline wax such that the “Drag Force density” Df required to move the cleaning sheet across a hard surface according to the “Glass Surface Test” is between about 3.5 g/cm² and about 10 g/cm², preferably 3.7 g/cm² and about 9 g/cm², more preferably 3.9 g/cm² and 5 g/cm².

In one embodiment, at least one of the outer surfaces of a cleaning sheet 10 is coated with an additive 20 comprising a wax, preferably a micro-crystalline wax such that the level of residue left on a hard surface is less than 1 according to the “Glass Surface Test.”

In order to evaluate the optimum composition and amount of additive on a cleaning substrate the following “Performance Comparison Tests” are conducted

Soil Pick-up Test Method

In order to conduct this test and evaluate the performance or cleaning efficacy of a sheet in terms of soil pick-up, a soil composed of ground black pepper (Distributed by The Kroger Company, Cincinnati, Ohio) can be used. This soil is chosen the relative difficulty to remove it from a hard surface and because its particle size distribution his close to the particle size distribution of typical soils found in houses. The particle size distribution of this simulated soil can be measured via a sieve analysis which can be done with USA STANDARD TESTING SIEVES #60, #35 and #18 (ASTM-11 Specification, Gilson Co. Worthington, Ohio). This sieve analysis shows that the ground black pepper soil has about one third of its particles by weight which are less than about 0.25 mm in diameter, one third of its particles by weight which range from about 0.25 to about 1 mm in diameter and one third of its particles by weight which are greater than about 1 mm in diameter. As previously discussed, this type of simulated soil (i.e., ground black pepper) is relatively difficult to remove from a surface with a dusting sheet because it contains oily components. In addition, the black pepper soil can easily be re-created or purchased and, as a result, is very re-producible.

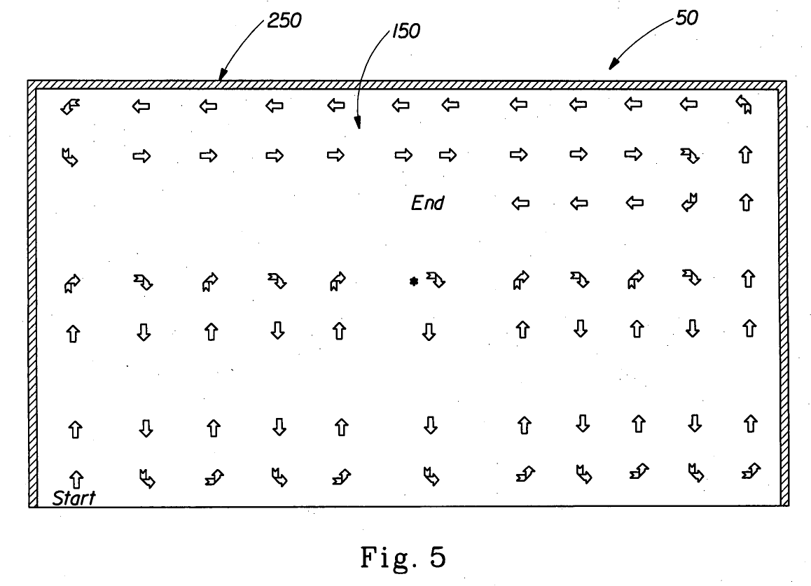

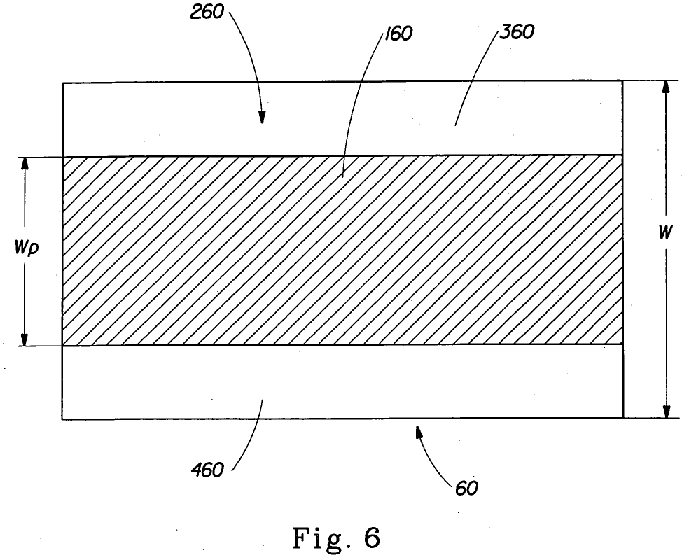

The test 50, schematically represented in FIG. 5, is conducted over a 1.5 m×2.1 m (2 feet×7 feet) area of vinyl flooring 150 (from Armstrong Signia Collection Flooring Model No. 62313, Item No. 46991). The perimeter of the floor area in the back and along its sides is surrounded by 3 walls 250 and base boards An area of about 0.91 m×0.91 m (3 feet×3 feet) is marked off directly in the center of floor to delineate the area where simulated soil is dispensed.

Soil Preparation:

Before removing a sample of simulated soil, the container including the ground pepper is shaken in order to homogenize the particle size distribution in the container. A tared weigh boat is used to measure a sample of about 0.35 g (±0.025 g) of pepper.

Surface Preparation:

Before spreading the sample of simulated soil on the vinyl flooring, this floor surface is cleaned using a solution containing about 20% IPA, 0.5% ammonia and the remainder of deionized water. The floor surface can initially be cleaned with a SWIFFER® WETJET® cleaning implement and a SWIFFER® WETJET® absorbent pad (both sold by The Procter & Gamble Company). About 50 mls of solution is sprayed on the floor area and wiped with the SWIFFER® WETJET® pad. Once the floor has dried, the floor surface is then rinsed with about 50 mls of de-ionized water and then dried thoroughly with BOUNTY® paper towels. When the floor has completely dried, it is then wiped evenly across its entire surface using a non-coated dusting sheet such as a SWIFFER® dry dusting sheet (which is a 67 gsm hydro-entangled polyester substrate) attached to a SWIFFER® sweeper. This standardizes the electrostatic charge of the surface.

The conditions of the test in terms of humidity and temperature of the room are checked and adjusted such that humidity of the room is within a range of 30% to 50% Relative Humidity (RH), and the temperature is between 18.3 and 23.8 degrees C. In addition, the cleaning sheet which are tested as well as the sample of simulated soil are allowed to sit in the room where the test is done for at least about one hour such that they adjust to the ambient room conditions.

A sample of about 0.35 g of simulated soil (i.e., ground pepper) is dispensed across the 0.91 m×0.91 m delineated area at the center of the floor surface.

A sample sheet of about 216 mm×279 mm is weighted using a 4 place analytical balance. The sample sheet is mechanically attached to a SWIFFER® sweeper such that the coated surface of the sheet is in direct contact with the floor surface. The SWIFFER® sweeper comprises a “crowned” (i.e., has an angle of curvature such that the leading and trailing edges of the mop head extend from about 2 mm off the floor surface) and a textured bottom surface (i.e., has a diamond shape pattern) such as the one currently available on the market and disclosed in U.S. patent application Ser. No. 09/788,761 to Willman et al., filed Feb. 24, 2000, and assigned to The Procter & Gamble Company.

Starting a the lower left hand corner, the floor surface is swept from the left to right, using an up and down S pattern motion as schematically represented in FIG. 5. During the sweeping operation, the mop head is kept in constant contact with the floor surface until substantially all the surface has been cleaned. After approximately 3 up and down strokes the mop head is swiveled in order to invert the leading and trailing edges such that both sides of the sheet are used to clean the surface. When the mop head is swiveled, some of the soil may fall off the sheet. If this happens, this portion of the floor surface is wiped again to recapture the soil, which fell off the sheet during the swiveling operation. Once this soil has been “recaptured” by the sheet, the up and down S-pattern motion is resumed for 3 more up and down strokes until all the floor surface has been cleaned.

When the mop head reaches the right wall, the sweeper is pushed straight until it reaches the upper right hand corner of the testing surface. The mop head is then rotated to the left and pushed across the back of the baseboard. When the mop head reaches the upper left hand corner of the testing surface, the mop head is rotated to the left, and pushed across the entire length of the floor surface. When the mop head reaches the right side wall, the mop head is rotated to the right and the soil pile is brought to the center area of the testing surface, as shown in FIG. 5

The mop head is carefully lifted off the floor and rotated such that the soiled sheet is facing upwards. The soiled sheet is carefully removed from mop head and folded inwardly to contain the collected soil. The soiled sheet is then weighted. The difference between the weight of the soiled and unsoiled sheet provides the amount of soil picked up by the sheet. The amount of soil, which is picked-up, is then divided by the amount of soil originally spread on the test surface and multiplied by 100 to obtain the percentage of picked-up soil.

A vacuum cleaner, or a broom, is used to remove any visual soil that is left on the test surface. A “fresh” (i.e., clean) non-coated SWIFFER® sheet is attached to sweeper and moved across the floor to once again standardize floor and to remove any fine soil that was missed from sweeping or vacuuming. A total of at least 5 sheets for each type of sample sheet are tested following the previous method. For each type of sample sheet, the recorded data are averaged data to obtain an average of percentage of picked-up soil.

After a specific type of sample sheet is tested, the floor surface is cleaned and re-standardized prior to testing a different type of sheet. The floor is cleaned thoroughly with a mild scrub brush with an IPA and ammonia solution as previously described. The floor is then cleaned with a WETJET® cleaning implement with a WETJET® cleaning pad and an IPA with ammonia solution. The floor is then rinsed with deionized water and dried with BOUNTY® paper towel. When it has substantially dried, the floor surface is wiped with an non-coated SWIFFER® sheet to remove any undesired fibers left from the BOUNTY® paper towel and standardize the electrostatic charge of the floor surface.

In one embodiment, one side of a cleaning sheet is coated with an additive comprising a wax, preferably a micro-crystalline wax, such that this coated side is capable of removing at least about 43%, preferably at least 46%, more preferably at least 48% and even more preferably at least 50% by weight of the particulates from a hard surface according to the Soil Pick-up Test. In one embodiment, the level of additive comprising a wax on the coated side is between about 0.1 g/m² and about 2.3 g/m², preferably between about 0.25 g/m² and about 2.0 g/m² and more preferably between about 0.4 g/m² and about 1.7 g/m².

Table 3 includes the results of this Performance Comparison for Soil Pick-up.

In order to evaluate the amount of residue left on a hard surface, cleaning sheets having different type of additives are tested according to the following test.

Performance Comparison for Residue Based on Change in Gloss Test Method.

A glass plate measuring about 200 mm by 250 mm is cleaned with a solution of 20% IPA and dried with a BOUNTY® paper towel. The glass is then placed over a matte semi-glossy ceramic tile surface. A gloss meter is laid flat on top surface of the glass plate, and then set such that the light scattering is at the 60 degrees setting. A suitable gloss meter can be obtained from BYK Gardner USA, Columbia Md. Three separate readings are obtained along the length of a substantially rectangular portion (measuring about 50 mm wide and 240 mm long) of the top surface of the glass plate. The first reading is obtained by placing the gloss meter substantially within the center of the 50 mm wide rectangular portion and at a distance of about 60 mm from the edge of the glass plate. The second reading is obtained by placing the gloss meter substantially within the center of the 50 mm wide rectangular portion and at a distance of about 120 mm from the edge of the glass plate. The third reading is obtained by placing the gloss meter substantially within the center of the 50 mm wide rectangular portion and at a distance of about 180 mm from the edge of the glass plate. The three initial readings obtained are averaged to provide a baseline for gloss of the non-treated surface (i.e., before any residue is left on the glass plate by a cleaning sheet having an additive). The average of initial gloss readings on the non-treated surface (glass plate over black ceramic tile) is about 155 units. The 200×250 mm glass plate is placed onto a scrubbing Machine (a suitable scrubbing machine is a Gardco Linear Test machine from Paul N. Gardner Company Inc). The machine comprises a carriage portion with a hollow centered portion where a solid block of material can be inserted. A sample test sheet is wrapped around a block which measures about 55 mm wide by about 100 mm long and which weights about 800 g (to create a pressure of about 14.1 g/cm² simulating hand dusting conditions). The sample test sheet which is about 216 mm wide by 279 mm long is wrapped around the block and then inserted into the carriage such that the surface of the sheet comprising an additive is in contact with the glass plate. The area of the sheet which is in contact with the plate is about 55 mm by 100 mm (corresponding to the X-Y dimensions of the block). The carriage of the scrubbing tester is returned to its original position. The back edge of the sheet wrapped around the block is lined up at about 5 mm in front of the leading edge of the glass plate. The scrubbing machine is started and the carriage is moved back and forth for a total of 20 strokes. One stroke corresponds to the block traveling in one direction one full path length of about 240 mm (measured from the back edge of the block). Once the block has traveled back and forth for a total of 20 strokes, the scrubbing machine is stopped and the glass plate is removed and then placed on top of the same black ceramic tile used to get the initial reference gloss meter readings (of about 155 units). Following the same procedure, three readings are obtained on the same location as previously discussed. Once the three gloss readings are recorded, the glass plate is cleaned and placed back on the top surface of the scrubbing machine. This test is repeated with two more similar sample sheets having the same type of additive in order to obtain a total of 9 readings for one type of additive. The 9 readings are averaged in order to determine an average gloss measurement of the glass surface. In order to evaluate the gloss change of the glass surface due to the residue left on the glass, the averaged readings of each type of additives are compared to the initial averaged reading. To evaluate the percent change in gloss due to residue, the following formula is used

$$Δ G = \frac{{G}_{initial} - {G}_{residue}}{{G}_{initial}} * 100$$

where ΔG is the change in gloss in percent, Gᵢₙᵢₜᵢₐₗ is the average initial gloss of the “non-treated” glass surface and G_{residue} is the average gloss of the glass surface having residue left from the sheet having an additive.

One skilled in the art will understand that when the glass surface is wiped with a substrate which does not have any additive, no residue is left on the glass surface and, as a result, there is no change in gloss measured. For the purpose of the invention described herein, a loss in gloss is represented by a negative value.

Table 3 shows the results of the “Change in Gloss Test” for different type of additives.

Tables 3 and 4 also include the results from the Performance Tests previously discussed.

TABLE 3

| | | | Penetration | | | Rolling | Relative | Gloss Loss |
|---|---|---|---|---|---|---|---|---|
| | | | Value | Coating | Soil | Ball Tack | Tack | Due to Residue |
| | Substrate | Coating Type | at 25° C. | Level | Pick-up | Distance | Rt | At 20 strokes |
| Example | Description | Supplier | (dmm) | (g/side) | (%) | (mm) | (%) | (%) |
| 1 | Swiffer | Uncoated | NA | 0 | 33.8 | 94.3 | | 0 |
| | 67 g/m² | | | | | | | |
| 2 | Swiffer | Paraffin | 15 | 0.04˜ | 39.0 | 91.9 | 97.5 | 3.7 |
| | 67 g/m² | | | 0.66 g/m² | | | | |
| 3 | Swiffer | Blended Mix of | 48 | 0.08˜ | 37.4 | 110.5 | 117.2 | 3.9 |
| | 67 g/m² | 70% Paraffin wax | | 1.33 g/m² | | | | |
| | | 30% Mineral Oil | | | | | | |
| 4 | Swiffer | Bees wax | 25 | 0.04 | 42.5 | 89.6 | 95.0 | 6.2 |
| | 67 g/m² | | | | | | | |
| 5 | Swiffer | Micro-wax | 63 | 0.04 | 54.5 | 75.5 | 80.1 | 8.9 |
| | 67 g/m² | Koster Kuenen 161 | | | | | | |
| 6 | Swiffer | Micro-wax | 25 | 0.04 | 43.5 | 86.1 | 91.3 | 8.4 |
| | 67 g/m² | Koster Kuenen 227 | | | | | | |
| 7 | Swiffer | Micro-wax | 63 | 0.04 | 54.2 | 85.5 | 90.7 | 5.4 |
| | 67 g/m² | Strahl & Pitsch #18 | | | | | | |
| 8 | Swiffer | Micro-wax | 70 | 0.04 | 54.9 | 72.6 | 77.0 | 8.0 |
| | 67 g/m² | Frank Ross 1275WH | | | | | | |
| 9 | Swiffer | Micro-wax | 45 | 0.04 | 51.6 | 82.6 | 87.6 | 12.4 |
| | 67 g/m² | Astor wax 3040 | | | | | | |
| 10 | Swiffer | Micro-wax | 75 | 0.04 | 58.6 | 77.3 | 82.0 | 13.7 |
| | 67 g/m² | Schaeffer #7 | | | | | | |
| 11 | Swiffer | Blended Mix of | 62 | 0.04 | 53.1 | 68.4 | 72.5 | 12.0 |
| | 67 g/m² | 80% Micro-wax | | | | | | |
| | | Koster Kuenen 161 | | | | | | |
| | | 20% Tacky Polymer | | | | | | |
| | | Polyisobutylene | | | | | | |
| | | (Vistanex LM-MS-LC by | | | | | | |
| | | ExxonMobil) | | | | | | |
| 12 | Swiffer | Blended Mix of | 35 | 0.04 | 50.1 | 77.0 | 81.7 | 19.8 |
| | 67 g/m² | 70% Parafin Wax | | | | | | |
| | | 30% Tacky Polymer | | | | | | |
| | | Polyisobutylene | | | | | | |
| | | (Vistanex LM-MS-LC by | | | | | | |
| | | ExxonMobil) | | | | | | |
| 13 | Swiffer | Blended Mix of | 32 | 0.04 | 46.6 | 87.9 | 93.2 | 20.3 |
| | 67 g/m² | 70% Parafin Wax | | | | | | |
| | | 30% Tacky Polymer | | | | | | |
| | | PureSyn 3000 | | | | | | |
| 14 | Swiffer | Hot melt | NA | 0.04 | 73.3 | 45.8 | 48.6 | Not Testable |
| | 67 g/m² | HB Fuller HL2713 | | | | | | Excessive |
| | | | | | | | | residue |
| 15 | Pledge Grab-It | Mineral Oil | NA | 0.08 | 35.5 | 143.8 | | 12.8 |
| | 58 g/m² | | | | | | | |
| 16 | Pledge Grab-It | Micro-wax | 63 | 0.04 | 50.5 | 117.7 | 81.8 | 25.0 |
| | 58 g/m² | Koster Kuenen 161S | | (on top of | | | | |
| | | (on top of existing | | 0.08 oil) | | | | |
| | | mineral oil on sheet) | | | | | | |
| 17 | Quickle by Kao | Mineral Oil | NA | 0.08 | 32.0 | 98.6 | | 10.6 |
| | Japanese | | | | | | | |
| | Market product | | | | | | | |
| | 60 g/m² | | | | | | | |
| 18 | Quickle by Kao | Micro-wax | 63 | 0.04 | 65.7 | 87.3 | 88.5 | 24.1 |
| | Japanese | Koster Kuenen 161S | | (on top of | | | | |
| | Market product | (on top of existing | | 0.08 oil) | | | | |
| | 58 g/m² | mineral oil on sheet) | | | | | | |

TABLE 4

| | | | Penetration | | | Rolling Ball | Relative |
|---|---|---|---|---|---|---|---|
| | | | Value | Coating | Soil | Tack | Tack |
| | | Coating Type | at 25° C. | Level | Pick-up | Distance | Rt |
| Example | Substrate Description | Supplier | (dmm) | (g/side) | (%) | (mm) | (%) |
| 19 | Exstatic Dust by Vileda | Uncoated | NA | 0 | 19.9 | 54.8 | |
| | US Market Product | | | | | | |
| | Needle Punch Substrate | | | | | | |
| | 130 g/m² | | | | | | |
| 20 | Exstatic Dust by Vileda | Micro-wax | 63 | 0.04 | 55.1 | 48.4 | 88.3 |
| | US Market Product | Koster Kuenen 161 | | | | | |
| | Needle Punched Substrate | | | | | | |
| | 130 g/m² | | | | | | |
| 21 | Everyday Living by | Uncoated | NA | 0 | 27.1 | 83.8 | |
| | Inter-American Products | | | | | | |
| | US Market Product | | | | | | |
| | Needle Punched Substrate | | | | | | |
| | 150 g/m² | | | | | | |
| 22 | Everyday Living by | Micro-wax | 63 | 0.04 | 67.8 | 61.2 | 73.0 |
| | Inter-American Products | Koster Kuenen 161 | | | | | |
| | US Market Product | | | | | | |
| | Needle Punched Substrate | | | | | | |
| | 150 g/m² | | | | | | |
| 23 | Chiffon Dust by | Uncoated | NA | 0 | 32.1 | 134.0 | |
| | Sunfresh Limited | | | | | | |
| | US Market Product | | | | | | |
| 24 | Chiffon Dust | Micro-wax | 63 | 0.04 | 58.1 | 118.1 | 88.1 |
| | Sunfresh limited | Koster Kuenen 161 | | | | | |
| | US Market Product | | | | | | |
| 25 | Bounty paper towel by | Uncoated | NA | 0 | 6.8 | 189.5 | |
| | Procter & Gamble | | | | | | |
| | US Market Product | | | | | | |
| | Wet Laid Paper | | | | | | |
| | 39 g/m² | | | | | | |
| 26 | Bounty paper towel by | Micro-wax | 63 | 0.06 | 21.5 | 173.9 | 91.8 |
| | Procter & Gamble | Koster Kuenen 161 | | | | | |
| | US Market Product | | | | | | |
| | Wet Laid Paper | | | | | | |
| | 39 g/m² | | | | | | |
| 27 | Electrostat EO30/115 by | Non-coated | NA | 0 | 41.2 | 102.7 | |
| | Hollinee | | | | | | |
| | Needle Puncheded Composite | | | | | | |
| | 30 g/m² PET/Modacrylic staple | | | | | | |
| | fiber (outer) | | | | | | |
| | 15 g/m² PP SB (middle) | | | | | | |
| | 45 g/m² | | | | | | |
| 28 | Electrostat EO30/115 by | Blended Mix of | 48 | 0.08 | 41.9 | 96.7 | 94.2 |
| | Hollinee | 70% Paraffin wax | | | | | |
| | Needle Puncheded Composite | 30% Mineral Oil | | | | | |
| | 30 g/m² PET/Modacrylic staple | | | | | | |
| | fiber (outer) | | | | | | |
| | 15 g/m² PP SB (middle) | | | | | | |
| | 45 g/m² | | | | | | |
| 29 | Electrostat EO30/115 by | Micro-wax | 63 | 0.04 | 62.7 | 78.6 | 81.3 |
| | Hollinee | Koster Kuenen 161 | | | | | |
| | Needle Puncheded Composite | | | | | | |
| | 30 g/m² PET/Modacrylic staple | | | | | | |
| | fiber (outer) | | | | | | |
| | 15 g/m² PP SB (middle) | | | | | | |
| | 45 g/m² | | | | | | |
| 30 | Apertured Spunlace | Uncoated | NA | 0 | 21.7 | 148.4 | |
| | 70% Rayon/30% PET | | | | | | |
| | 70 g/m² | | | | | | |
| 31 | Apertured Spunlace | Blended Mix of | 48 | 0.08 | 32.6 | 148.5 | 100.1 |
| | 70% Rayon/30% PET | 70% Paraffin wax | | | | | |
| | 70 g/m² | 30% Mineral Oil | | | | | |
| 32 | Apertured Spunlace | Micro-wax | 63 | 0.04 | 47.5 | 136.0 | 91.6 |
| | 70% Rayon/30% PET | Koster Kuenen 161 | | | | | |
| | 70 g/m² | | | | | | |
| 33 | Cotton flannel | Uncoated | NA | 0 | 30.9 | 122.4 | |
| | 150 g/m² | | | | | | |
| 34 | Cotton flannel | Blended Mix of | 48 | 0.08 | 41.8 | 118.5 | 96.8 |
| | 150 g/m² | 70% Paraffin wax | | | | | |
| | | 30% Mineral Oil | | | | | |
| 35 | Cotton flannel | Micro-wax | 63 | 0.04 | 73.9 | 89.4 | 75.4 |
| | 150 g/m² | Koster Kuenen 161 | | | | | |
| 36 | Cheese cloth | Non-coated | NA | 0 | 28.5 | 125.2 | |
| | 100% Cotton | | | | | | |
| | 190 g/m² | | | | | | |
| 37 | Cheese cloth | Blended Mix of | 48 | 0.08 | 32.3 | 130.8 | 104.5 |
| | 100% Cotton | 70% Paraffin wax | | | | | |
| | 190 g/m² | 30% Mineral Oil | | | | | |
| 38 | Cheese cloth | Micro-wax | 63 | 0.04 | 47.4 | 101.0 | 77.2 |
| | 100% Cotton | Koster Kuenen 161 | | | | | |
| | 190 g/m² | | | | | | |

The data in Table 3 shows the benefits of having an additive comprising a wax and in particular a micro-crystalline wax which is coated on variety of substrates.

Examples 1 through 14 include a substrate used for SWIFFER® dusting sheets which are coated with different chemistries. This substrate is made by a spunlace process in which two layers of carded polyester staple fibers are hydroentangled around a polypropylene spunbond web.

The results of Example 2 in comparison to Example 1 show that coating a substrate with a paraffin wax provides only a slight improvement in soil pick-up.

The results of Example 3 show that by adding mineral oil to the paraffin, the penetration of the wax mixture can be increased from 15 dmm when the additive is 100% paraffin, to 48 dmm when the additive is a 70:30 mixture of paraffin/mineral oil. It can be appreciated that even with a higher penetration value the soil pick-up of a sheet with this additive is substantially the same as the soil pick-up of the sheet with an additive made of 100% paraffin. Without intending to be bound by any theory, it is believed that this is due to the relatively high Rt value for this mixture (i.e., low tack properties).

In comparison the results of Examples 5, 6, 7, 8, 9 and 10 which correspond to cleaning substrates coated with additives comprising different type of micro-crystalline waxes, show a significant increase in soil pick-up when compared to the non-coated substrate of Examples 1, 2 and 3. Without intending to be bound by any theory, it is believed that these results are obtained because these micro-crystalline waxes have good tack properties in addition to relatively high penetration values. In one embodiment, at least one of the outer surfaces of a cleaning sheet is coated with an additive comprising a wax such that the additive has a penetration values at 25° C. of at least about 20 dmm and a Relative Tack Rt between about 55% and about 94%, preferably between about 60% and about 92%, more preferably between about 65% and about 90%.

The results of Example 11 show that the performance of an additive comprising a micro-crystalline wax which is relatively harder (i.e., has a penetration value of less than about 25 dmm at 25° C.), can be enhanced by the addition of low levels of a tacky polymer. The addition of the tacky polymer increases the penetration from 25 dmm for the micro-crystalline wax alone to about 62 dmm for an 80:20 mixture of the same micro-crystalline wax with a tacky polymer (Polyisobutylene). The soil pick-up performance of a sheet with this additive mixture is higher in comparison to the additive with wax alone and approaches the same pick-up exhibited by the micro-crystalline waxes which has a higher penetration value (such in Examples 5, 7, 8, 9 and 10). In addition, an additive having such a micro-crystalline wax/tacky polymer mixture achieves an acceptable amount of residue (i.e., the loss in gloss is less than about 15%).

The results of Examples 12 and 13 show that relatively low levels of tacky polymers can also be added to other type of waxes such as paraffins and still provide some benefits. Since the paraffin wax has an even lower penetration value (about 15 dmm at 25° C.) and a lower relative tack, the amount of tacky polymer needs to be increased in order to increase both penetration and the relative tack value. A 70:30 mixture of paraffin/tacky polymer has a penetration value of about 35 dmm at 25° C. and a relative tack value Rt between about 50% and about 94%, preferably between about 55% and about 92%, more preferably between about 60% and about 90%. Although the soil pick-up value of a sheet coated with such an additive is lower than the soil pick-value of a sheet coated with an additive comprising micro-crystalline waxes or micro-crytalline/tacky polymer mixtures, this soil pick-up value is nevertheless higher than the soil pick-up value of the sheet coated with paraffin alone (Example 2) or even with the 70:30 paraffin/mineral oil additive of Example 3. The soil pick-up performance can be further increased by adding an even tackier polymer. However, with a 70:30 paraffin:tacky polymer additive, the residue left behind starts approaching the high end of acceptability.

The results of Example 14 show that a cleaning sheet coated with an additive comprising only a tacky polymer has excellent soil pick-up performance which exceed the performance of the sheet coated with an additive comprising micro-crystalline waxes. However, as previously discussed, such an additive can only be effectively used on floor surfaces since on glass surfaces, tacky polymers lead to unacceptable amount of residue and also make the sheets difficult to move across surfaces. This observation is also confirmed by the low relative tack Rt (about 50%).

The results of Examples 15 to 18 show that the soil pick-up value of other type of substrates is significantly increased when an additive comprising micro-crystalline waxes is added. In Examples 15 and 16, the cleaning sheet is a PLEDGE GRAB-IT® cleaning sheet, sold by the S.C. Johnson Company, which is made via a spunlace process in which carded polyester fibers are hydroentangled around a polypropylene scrim netting material. In Examples 17 and 18, the cleaning sheet is a QUICKLE® cleaning sheet sold by the Kao Company which is made via a spunlace process in which carded polyester fibers are hydroentangled around a polypropylene scrim netting material. During the spunlace process, the web is hydroentangled on a forming belt.

Surprisingly, it is observed that the cleaning performance of sheets which already have an additive can be further improved by “over-coating” an additive comprising a micro-crystalline wax on top of the first additive comprising an oil. Over-coating these sheets with micro-crystalline wax significantly increases the cleaning performance in comparison to reference sheets only coated with mineral oil. However, by over-coating on top of a mineral oil additive, the sheets approaches residue levels which are at the high end of acceptability. Without intending to be bound by any theory, it is believed that this result is due to the fact that since mineral oil is underneath the micro-crystalline wax, the micro-crystalline wax can more easily shear off from the substrate and, as a result, be deposited onto the hard surface. One skilled in the art will understand that improved results, from a residue standpoint, can be obtained by applying an additive comprising a micro-crystalline wax onto a substrate which has not been previously coated with a mineral oil additive.

The results of Examples 19 to 24 show that the soil pick-up performance of other type of substrates is increased when the substrate is coated with an additive comprising micro-crystalline waxe(s). Although the substrates of these examples are structurally different from the substrates of Examples 1 through 14, (as they have a higher basis weight and are made via a needle punching non-woven process as opposed to the spunlaced process used by the other dusting sheets), they demonstrate a significant increase in performance when coated with an additive comprising a micro-crystalline wax.

The results of Examples 25 to 38 show that the cleaning performance (i.e., soil pick-up value) of a variety of substrate materials ranging from a paper towel to a cotton flannel, can be increased in comparison to the same non-coated substrate or the same substrate material coated with a 70:30 Paraffin wax/mineral oil additive mixture.

In one embodiment, at least one of the outer surfaces of a dusting sheet is coated with an additive comprising a wax or a wax mixture, preferably a micro-crystalline wax, such that the additive has a penetration value at 25° C. between about 20 dmm and about 100 dmm, preferably between about 25 dmm and about 90 dmm, more preferably between about 25 dmm and about 80 dmm, and a relative tack value Rt between about 55% and about 94%, preferably between about 60% and about 92%, more preferably between about 65% and about 90%.

In a preferred embodiment, the additive applied on the sheet comprises a mixture of a wax, preferably a micro-crystalline wax, and a tacky polymer such that the amount of tacky polymer is less than about 40% by weight of the mixture, preferably less than about 30% by weight of the mixture and more preferably less than 20% by weight of the mixture.

In addition to the previously discussed factors leading to a poor perception of a dry cleaning sheet by a user (inconvenience to move the sheet across the surface to be cleaned and residue left on the surface), it is found that additives on a sheet can also have an impact on the “hand feel” perception of the user. Cleaning sheets are typically folded and stacked in a carton or a plastic package. Since the user needs to pull one sheet from the package in order to attach it to a cleaning tool, his/her hands can potentially get in contact with the relatively tacky additive, in particular when the substrate is substantially flat (i.e., does not have a macroscopic three-dimensional pattern). In other words the consumer can find the sticky feel of the sheet unacceptable. One possible way to reduce this poor “hand feel” perception is to keep the coating level of the additive as low as possible without sacrificing the cleaning performance. Another possible way to limit this poor “hand feel” is to apply the additive coating on only one of the outer surfaces of the sheet thereby reducing the possibility of contact between the hand of the user and the additive.

When only one side of the sheet is coated with an additive, the user may not realize how to attach the sheet to a cleaning tool or even hold the sheet such that the coated side is the one in contact with the hard surface during the cleaning operation. One possible solution to intuitively indicate how to use or attach the sheet is to fold the sheet (prior to place it in a package) such that the non-coated side is folded in on top of itself with the coated side out. When a sheet is folded as previously described, the creases (or folding lines) created by the folding are such that when the sheet is opened it becomes intuitive from the crease marks which part of the sheet contacts the mophead and which part faces the floor surface. To further identify the coated side from the non-coated side, the sheet substrate can be textured or have more of a three dimensional pattern on one side and be substantially flat and smooth on the other side. Typically since texturing and three-dimensionality of at least one surface of the sheet aid in large particle pick-up, the coating is preferably placed on this side since large particle pick-up is more difficult than dust and lint pick-up.

In one embodiment shown in FIG. 6, only a portion of at least one of the outer surfaces of a cleaning sheet 60 comprises an additive 160 such as any of the previously discussed additives. In one embodiment, the additive is applied on at least one of the outer surfaces of a sheet such that the additive is located on a middle portion 260 of the sheet. In one embodiment, the portion 260 which is coated with the additive 160 has a width Wp which is between about 10% and about 90%, preferably between about 20% and about 80%, more preferably between about 30% and about 70%, even more preferably between about 40% and about 60% of the total width W of the cleaning sheet 60. In a preferred embodiment, the remaining portions 360 and 460 of the sheet which are respectively located adjacent to the front and back leading edges of the sheet, are substantially free from an additive. Most sweepers include attachment structures or grippers such as the ones disclosed in U.S. Pat. No. 6,305,046 to Kingry et al., issued Nov. 23, 2001, and assigned to The Procter & Gamble Company, where the user insert a portion of the sheet to mechanically attach the sheet to the mop head. Among other benefits, a cleaning sheet having an additive applied on a middle portion of the outer surface(s) of a sheet allows a user to mechanically attach the sheet to the mop head of a cleaning implement without getting in contact with the additive.

In one embodiment, the sheet can be advertised as being specialized for different surfaces. One side (i.e., the coated side) for removing larger particulates and the other side for removing smaller particulates such as dust. To aide in determining which side is which the sheets can be printed with instructions or indications, or a colored dye can be added directly to the additive.

Another benefit of only coating one side of the sheet with an additive is that in the event the additive leaves a residue and the surface being cleaning, this residue can easily be removed by using the non-coated side to remove (or buff) the residue.

In one embodiment, a first surface of a sheet can be coated with a tacky additive as previously discussed and the other side of the sheet can be coated with a lubricant. Without intending to be bound by any theory, it is believed that a lubricant mitigates the poor “hand feel” perception. By getting lubricant on the user's fingers the tackiness from the additive on the opposite side is not as noticeable. Non-limiting examples of suitable lubricants include mineral oils, petrolatum, silicone oils, surfactants and mixtures thereof. The lubricating side of the sheet can also be coated with chemistries that nourish and/or protect the user's skin. Non-limiting examples of such chemistries include actives and actives mixtures such as Vitamin E oil, aloe vera, jojoba oil, wheat germ oil, petitgrain oil, essential oils such as lavendar, lemongrass, geranium and the like, Ubiquinol (active form co-enzyme Q10), Panthenol (pro vitamin B5), collagen, and mixtures thereof.

One skilled in the art will understand that the additive previously discussed are not limited to cleaning sheets.

In one embodiment, a substrate coated with any of the additive previously discussed, can be formed into a mitt such as the one disclosed in U.S. Pat. No. 5,968,204 to Wise, issued Oct. 19, 1999 and assigned to The Procter & Gamble Company, such that at least one of the outer surfaces of the mitt comprises an additive as previously discussed.

In another embodiment, the additive can be applied onto at least some of the fibers of a duster such as disclosed in International Patent Application WO 02/34101 to Tanaka, published May 2, 2002, and assigned to the Uni-Charm Corporation which comprises a mop body which is removably attachable to a cleaning tool comprising a handle.

In one embodiment, cleaning sheets comprising an additive as previously described, can be used with combination with a cleaning tool comprising a handle and a mop head. In one embodiment, the previously discussed cleaning sheets can be sold as a cleaning kit comprising at least cleaning sheet and a cleaning tool.

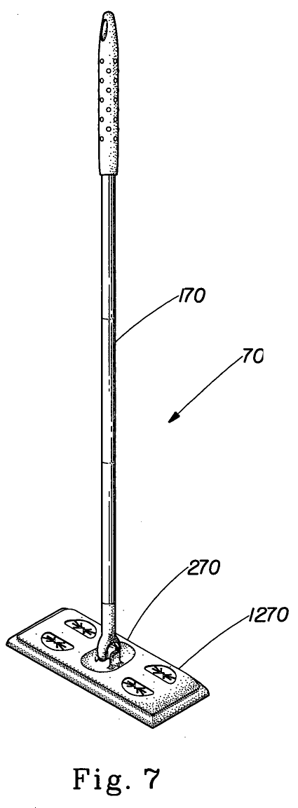

FIG. 7 shows a cleaning tool 70 which comprises a handle 170 and preferably includes a mop head 270 rotatably connected the handle 170. An example of cleaning tool is described in U.S. patent application Ser. No. 09/788,761 to Willman et al., filed Feb. 24, 2000, and assigned to The Procter & Gamble Company. The mop head 270 can have any shape or size and includes attachment structures 1270 for retaining a cleaning sheet about the mop head as described in U.S. Pat. No. 6,305,046 to Kingry et al., issued Oct. 23, 2001, and assigned to The Procter and Gamble Company, but one skilled in the art will understand that any other kind of retaining means can be used to retain a cleaning sheet and provide the same benefits.

The cleaning sheets described herein can be made using either a woven or nonwoven substrate(s) via several processes. Non-limiting example of processes suitable to make the cleaning sheets include forming operations using melted materials laid down on forms, especially in belts, forming operations involving mechanical actions/modifications carried out on films, imaging/patterning process involving an imaging device having a drum with an imaging surface and/or by embossing operations and combinations thereof. The substrates used for the cleaning sheet with pillow members can made by any number of methods (e.g., hydroentangled, spunbonded, meltblown, carded resin bonded, carded through air-bonded, carded thermal bonded, air laid, etc.), once the essential three dimensional dimensions and basis weight requirements are determined. However, the preferred substrates are nonwoven, and especially those formed by hydroentanglement as is well known in the art, since they provide highly desirable open fibrous structures. Therefore, preferred cleaning sheets are nonwoven substrates having the characteristics described herein. Materials particularly suitable for forming the preferred nonwoven cleaning sheet of the present invention include, for example, natural cellulosics as well as synthetics such as polyolefins (e.g., polyethylene and polypropylene), polyesters, polyamides, synthetic cellulosics (e.g., RAYON®), and blends thereof. Also useful are natural fibers, such as cotton or blends thereof and those derived from various cellulosic sources. Preferred starting materials for making the hydroentangled fibrous sheets are synthetic materials, which may be in the form of carded, spunbonded, meltblown, airlaid, or other structures. Particularly preferred are polyesters, especially carded polyester fibers. The degree of hydrophobicity or hydrophilicity of the fibers is optimized depending upon the desired goal of the sheet, either in terms of type of soil to be removed, the type of additive that is provided, when an additive is present, biodegradability, availability, and combinations of such considerations. In general, the more biodegradable materials are hydrophilic, but the more effective materials tend to be hydrophobic.

The cleaning sheets may be formed from a single fibrous layer, but preferably are a composite of at least two separate layers. Preferably, the sheets are nonwovens made via a hydroentangling process. In this regard, prior to hydroentangling discrete layers of fibers, it may be desired to slightly entangle each of the layers prior to joining the layers by entanglement.

The cleaning sheets described herein can have a basis weight of at least about 40 g/m², preferably between about 50 g/m² and 90 g/m², more preferably between about 55 g/m² and about 80 g/m².

While particular embodiments of the subject invention have been described, it will be apparent to those skilled in the art that various changes and modifications of the subject invention can be made without departing from the spirit and scope of the invention. In addition, while the present invention has been described in connection with certain specific embodiments thereof, it is to be understood that this is by way of limitation and the scope of the invention is defined by the appended claims which should be construed as broadly as the prior art will permit.

What is claimed is:

1. A cleaning sheet for cleaning a surface comprising:
a substrate comprising at least one layer of fibrous material, said substrate having a first side and a second side; and
an additive applied on at least said first side wherein said additive comprises a wax and wherein said additive has a penetration value at 25° C. of between about 20 dmm and about 100 dmm, and wherein said additive is applied on said first side at a level of between about 0.1 g/m² and about 2.3 g/m².

2. The cleaning sheet of claim 1 wherein said additive is applied on said first side at a level between about 0.25 g/m² and about 2.0 g/m².

3. The cleaning sheet of claims 2 wherein said additive is applied on said first side at a level between about 0.4 g/m² and about 1.7 g/m².

4. The cleaning sheet of claim 1 wherein said additive has a penetration value of between about 25 dmm and about 90 dmm.

5. The cleaning sheet of claim 4 wherein said additive has a penetration value of between about 25 dmm and about 80 dmm.

6. The cleaning sheet of claim 1 wherein said wax is a micro-crystalline wax and wherein the additive has a penetration value at 25° C. of between about 30 dmm and about 100 dmm.

7. The cleaning sheet of claim 1 wherein said additive comprises a mixture of a micro-crystalline wax, said micro-crystalline wax having a penetration value at 25° C. of less than about 30 dmm, and an oil, wherein the penetration value of said additive is between 30 dmm and about 100 dmm.

8. The cleaning sheet of claim 1 wherein said additive further comprises a tacky polymer and wherein the penetration value of said additive at 25° C. is between about 30 dmm and about 100 dmm.

9. The cleaning sheet of claim 8 wherein said tacky polymer is selected from the group consisting of polyisobutylene polymers, alkyl methacrylate polymers, polyalkyl acrylates, polydecenes, natural, and mixtures thereof.

10. The cleaning sheet of claim 8 wherein said wax is a micro-crystalline wax.

11. A cleaning sheet for cleaning a surface comprising:
a substrate comprising at least one layer of fibrous material, said substrate having a first side and a second side; and
an additive applied on at least said first side wherein said additive comprises a wax and wherein said additive has a penetration value at 25° C. of between about 20 dmm and about 100 dmm, and wherein said additive has a Rt which is between about 55% and about 94%.

12. The cleaning sheet of claim 11 wherein said Rt is between about 60% and about 92%.

13. The cleaning sheet of claim 12 wherein said Rt is between about 65% and about 90%.

14. The cleaning sheet of claim 11 wherein said additive is applied on said first side at a level of between about 0.1 g/m² and about 2.3 g/m².

15. The cleaning sheet of claim 14 wherein said additive is applied on said first side at a level between about 0.25 g/m² and about 2.0 g/m².

16. The cleaning sheet of claim 15 wherein said additive is applied on said first side at a level between about 0.4 g/m² and about 1.7 g/m².

17. The cleaning sheet of claim 11 wherein said wax is a micro-crystalline wax.

18. A cleaning sheet for cleaning a surface comprising:
a substrate comprising at least one layer of fibrous material, said substrate having a first side and a second side; and
an additive applied on at least said first side wherein said additive comprises a wax and wherein said additive has a penetration value at 25° C. of between about 20 dmm and about 100 dmm, wherein said additive is applied on said first side and wherein said first side having said additive has a Df measured according to a “Glass Surface Test” between about 3.5 g/cm² and about 10 g/cm².

19. The cleaning sheet of claim 18 wherein said Df is between about 3.7 g/cm² and about 9 g/cm².

20. The cleaning sheet of claim 19 wherein said Df is between about 3.9 g/cm² and about 5 g/cm².

21. The cleaning sheet of claim 18 wherein said wax is a micro-crystalline wax.

22. The cleaning sheet of claim 18 wherein said additive is applied on said first side at a level of between about 0.1 g/m² and about 2.3 g/m².

23. The cleaning sheet of claim 22 wherein said additive is applied on said first side at a level between about 0.25 g/m² and about 2.0 g/m².

24. The cleaning sheet of claim 23 wherein said additive is applied on said first side at a level between about 0.4 g/m² and about 1.7 g/m².

25. A cleaning sheet for cleaning a surface with a low level of residue comprising:
a substrate comprising at least one layer of fibrous material, said substrate having a first side and a second side; and
an additive applied on at least said first side wherein said additive comprises a micro-crystalline wax and wherein said additive has a penetration value at 25° C. of between about 30 dmm and about 100 dmm, wherein said additive is applied on said first side at a level between about 0.1 g/m² and about 2.3 g/m² and wherein the loss in gloss of said surface according to the “Residue Test Method” is less than about 25%.

26. The cleaning sheet of claim 25 wherein the loss in gloss of said surface according to the “Residue Test Method” is less than about 20%.

27. The cleaning sheet of claim 26 wherein the loss in gloss of said surface according to the “Residue Test Method” is less than about 15%.

28. A cleaning sheet for cleaning a surface comprising:
a substrate comprising at least one layer of fibrous material, said substrate having a first side and a second side; and
an additive applied on at least said first side wherein said additive comprises a wax, and wherein said first side coated with said additive has a Rt value between about 55% and about 94% and wherein said first side coated with said additive removes at least about 43% by weight of the particulates from said hard surface measured according to the “Soil Pick-up Test”.

29. The cleaning sheet of claim 28 wherein said first side coated with said additive removes at least about 46% by weight of said particulates.

30. The cleaning sheet of claim 29 wherein said first side coated with said additive removes at least about 48% by weight of said particulates.

31. The cleaning sheet of claim 28 wherein said Rt is between about 60% and about 92%.

32. The cleaning sheet of claim 31 wherein said Rt is between about 65% and about 90%.

33. The cleaning sheet of claim 28 wherein said additive is applied on said first side at a level of between about 0.1 g/m² and about 2.3 g/m².

34. The cleaning sheet of claim 33 wherein said additive is applied on said first side at a level between about 0.25 g/m² and about 2.0 g/m².

35. The cleaning sheet of claim 34 wherein said additive is applied on said first side at a level between about 0.4 g/m² and about 1.7 g/m².

36. A cleaning sheet for cleaning a surface comprising:
a substrate comprising at least one layer of fibrous material, said substrate having a first side and a second side; and
an additive applied on at least said first side wherein said additive comprises a wax, and wherein said first side coated with said additive has a Rt value between about 55% and about 94%, wherein said additive is applied on said first side at a level between about 0.1 g/m² and about 2.3 g/m² and wherein the loss in gloss of said surface according to the “Residue Test Method” is less than about 25%.

37. The cleaning sheet of claim 36 wherein the loss in gloss of said surface according to the “Residue Test Method” is less than about 20%.

38. The cleaning sheet of claim 37 wherein the loss in gloss of said surface according to the “Residue Test Method” is less than about 15%.

39. The cleaning sheet of claim 36 wherein said additive is applied on said first side at a level between about 0.25 g/m² and about 2.0 g/m².

40. The cleaning sheet of claim 36 wherein said additive is applied on a middle portion of said first side wherein the width of said middle portion is between about 10% and about 90% of the width of said cleaning sheet.

41. The cleaning sheet of claim 36 wherein said additive is applied on said first side at a level between about 0.4 g/m² and about 1.7 g/m².

42. A cleaning sheet for cleaning a surface comprising:
a substrate comprising at least one layer of fibrous material, said substrate having a first side and a second side;
a first additive applied to said first side, wherein said first additive comprises a wax; and
a second additive applied to said second side wherein said second additive is substantially free of wax.

43. The cleaning sheet of claim 42 wherein said first additive has a Rt value between about 55% and about 94%

44. The cleaning sheet of claim 43 wherein said first additive further comprises a tacky polymer

45. The cleaning sheet of claim 44 wherein said tacky polymer is selected from the group consisting of polyisobutylene polymers, alkyl methacrylate polymers, polyalkyl acrylates, polydecenes, and mixtures thereof.

46. The cleaning sheet of claim 42 wherein said second additive is selected from the group consisting of mineral oils, petrolatum, silicone oils, surfactants, Vitamin E oil, aloe vera, jojoba oil, wheat germ oil, petitgrain oil, essential oils, collagen, and mixtures thereof.

47. A method of cleaning a surface comprising:
providing a cleaning sheet having a first side and a second side, wherein said first side comprises a first additive, wherein said first additive comprises a wax and wherein said first side has a Rt which is between about 55% and about 94% and wherein said second side comprises a second additive wherein said second side has a Rt which is greater than about 94%; and
wiping said surface with said cleaning sheet.

48. The method of claim 47 wherein said first additive comprises a micro-crystalline wax.

49. The method of claim 48 wherein said second additive comprises an oil.

50. The method of claim 47 wherein at least one of said first or second sides comprise instructions printed on said first or second sides.

51. The method of claim 47 wherein at least one of said first or second additives further comprises a colored dye.
